(19) United States
(12) Patent Application Publication
(10) Pub. No.: US 2026/0311471 A1
(43) Pub. Date: Oct. 8, 2026

(54) MACHINE LEARNING MODEL TRAINING PARAMETER OPTIMIZATION

(71) Applicant: Lumina AI, LLC, Tampa, FL (US)

(72) Inventors: Morten Middelfart, Tampa, FL (US); Benjamin A. Martin, Tampa, FL (US); Samuel Martin, Tampa, FL (US); Fadi G. Farhat, New York, NY (US)

(73) Assignee: Lumina AI, LLC, Tampa, FL (US)

(21) Appl. No.: 19/638,771

(22) Filed: Apr. 3, 2026

Related U.S. Application Data
(60) Provisional application No. 63/783,819, filed on Apr. 4, 2025.

(51) Int. Cl. G06V 10/776; G06V 10/764; G06V 10/77; G06V 10/771

(52) U.S. Cl. CPC G06V 10/776; G06V 10/764; G06V 10/771; G06V 10/7715

(57) ABSTRACT

Described herein are techniques for using an auto-optimization process to determine a set of parameters and parameter values describing a relationship between classes in a dataset. This set of parameters and parameter values can be used to predict, for a given sample based on a candidate function described by the set of parameters and parameter values, a classification for that sample. The candidate function, including the set of parameters and parameter values, may be provided to an artificial intelligence model or random contrast learning (RCL) model for training.

### CROSS-REFERENCE TO RELATED APPLICATION

The present application claims the benefit of priority of U.S. Provisional Patent Application No. 63/783,819, filed Apr. 4, 2025. The contents of this provisional application are incorporated herein by reference in their entirety.

### BACKGROUND

Performance of machine learning models, including models that implement Random Contrast Learning (RCL), during training or inference operations can depend on how the models are trained. However, given the complexity of the solution space of model training parameters, it can be challenging to efficiently identify appropriate model training parameters for a given model or task for which the model is to be deployed.

### SUMMARY

The systems and methods described herein can determine training parameters and evaluation methods for training machine learning models. A technical benefit of the technical solutions related to determining the training parameters and evaluations methods include ensuring that the trained machine learning models can effectively handle diverse data patterns and characteristics, leading to more accurate and reliable performance improvements. These training parameters and evaluation methods can improve the training process, including producing a trained model with improved accuracy more efficiently.

Optimizing training parameters for machine learning models, including within the context of Random Contrast Learning (RCL), can allow for faster and more accurate model learning. Given the complexity of the training parameter search space, a technical problem arises in identifying evaluation methods and parameter settings that can accurately assess and improve performance of these models. The technical solution to this problem includes an auto-optimization process for determining, for a given dataset, training parameters that can satisfy one or more performance criteria. In some examples, this auto-optimization process can include various evaluation methods such as Chi-Squared, Fractal, Naïve Bayes, SoftMax, or others. Each of these evaluation methods may evaluate patterns in data samples differently, and therefore identifying the method is a foundational step in the model configuration process.

The application of RCL to the configuration of language models, including large language models (LLMs), can significantly reduce computational requirements, including power consumption and time, compared to traditional methods such as transformer neural networks (TNNs). In some implementations, RCL's pre-training efficiency allows scalable training on CPU-based systems while maintaining or exceeding the accuracy and generalization of existing LLM architectures. Systems and methods in accordance with the present disclosure can address limitations of existing TNN-based pre-training techniques and across various hardware configurations, including CPUs and FPGAs.

RCL-based models for LLMs offer several technical advantages when compared to TNNs. For example, RCL-based models can perform as well or better than TNNs while improving training speeds. In some scenarios, the training speed increase can be orders of magnitude large. Additionally, as the complexity of the datasets increase, the training speed improvements can be maintained. TNNs, on the other hand, can experience significant performance drop off as complexity increases. One technique implemented to increase training speed, as well as decrease inference time, can be using a join operation to join the input sequence token's encoded representations, which allows the RCL-based models to perform predictive tasks significantly faster, using fewer computational resources, than transformer-based architectures.

In some implementations, a set of parameters for a candidate function can be selected. The set of parameters for the candidate function can describe a relationship between a first class of data samples and a second class of data samples from a training dataset. The training dataset can include different data types, such as text, images, or other data types. The second class of data samples can be of the same data type as the first class of data samples. For example, if the first class of data samples is a first class of images, the second class of data samples can include a second class of images. The training dataset can include a plurality of data samples (e.g., a plurality of images) having a first label or a second label. The first label and the second label can indicate whether a given data sample (e.g., a given image) of the plurality of data samples was classified into the first class of data samples or the second class of data samples, respectively. For each data sample (e.g., image) of a set of data samples (e.g., sample images), a predicted label for a sample image randomly selected from the training dataset can be determined using the candidate function having the set of parameters. Values associated with the set of parameters for the candidate function can be extracted based on the predicted label for the data sample (e.g., the sample image). After each image of the set of sample images has had a predicted label determined and values associated with the set of parameters extracted, an accuracy of the candidate function can be computed using an accuracy metric. Based on the accuracy satisfying a performance criterion, one or more training parameters can be output.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. As used in the specification and in the claims, the singular form of “a,” “an,” and “the” include plural referents unless the context clearly dictates otherwise.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1 is a block diagram of an example system for performing an auto-optimization process, in accordance with one or more implementations.

FIG. 2 is an illustrative diagram of data splitting for training, testing, and validating, in accordance with one or more implementations.

FIG. 3 is an illustrative flowchart of an example process for determining a set of parameters and parameter values for a given training dataset, in accordance with one or more implementations.

FIG. 4 is an illustrative diagram of an example data pipeline, in accordance with one or more implementations.

FIG. 5 is an illustrative diagram of an example system used to train models, in accordance with one or more implementations.

### DETAILED DESCRIPTION

Before turning to the figures, which illustrate the exemplary implementations in detail, it should be understood that the present disclosure is not limited to the details or methodology set forth in the description or illustrated in the figures. It should also be understood that the terminology used herein is for the purpose of description only and should not be regarded as limiting.

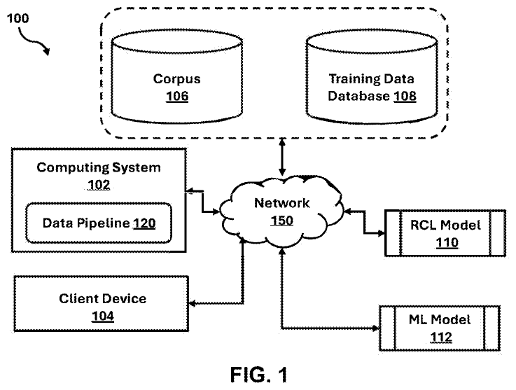

FIG. 1 is a block diagram of an example system for performing an auto-optimization process, in accordance with one or more implementations. In some implementations, system 100 can determine a set of parameters, as well as parameter values, for a given set of training data to optimize the training of a model using that training data. In some examples, the set of training data with which the set of parameters is determined corresponds to an RCL-based model. As an example, the parameters may include an evaluation metric, which can be selected from amongst a set of possible evaluation metrics (e.g., Chi-Squared, Fractal, Naïve Bayes, SoftMax, or others).

System 100 may include a computing system 102. Computing system 102 can communicate with other components of system 100 via network 150 (e.g., the Internet, one or more Intranets, etc.). For example, Application Programming Interface (API) calls to one or more client devices, such as a client device 104, one or more databases, such as corpus 106 or training data database 108, one or more models, such as RCL model 110 or ML model 112, or other components of system 100, may transmitted across network 150. In some examples, computing system 102 can train a model using an RCL-training process to obtain RCL model 110. Computing system 102 may also be configured to deploy/host services for RCL model 110.

In some implementations, computing system 102 may include one or more processors, memory, storage, input/output (I/O) interfaces, and network connectivity. The processors may include central processing units (CPU). In some cases, one or more GPUs may be included by computing system 102 in addition to one or more CPUs. Furthermore, in some examples, the RCL-based training process can be implemented on computing systems having GPU-based architectures. However, as discussed herein, one of the technical advantages of the disclosed implementations is the ability to formulate predictions without requiring GPU-based architectures, enabling training and deployment of prediction models using CPU-based architectures. The processors of computing system 102 (e.g., the CPUs) can execute instructions and processes data. The memory of computing system 102 can store these instructions and data temporarily for quick access. Storage devices, such as hard drives or solid-state drives, can provide long-term data storage functionalities. I/O interfaces facilitate communication with peripheral devices like keyboards, mice, displays, or other components. Furthermore, computing system 102 may include communications systems for supporting network connectivity (e.g., connecting to network 150). The connections may be wired or wireless and can enable communications with other components of system 100 or devices external to system 100. Computing system 102 can perform various tasks, including data processing, storage, and communication, efficiently and reliably. In some implementations, computing system 102 can perform an auto-optimization process to identify a set of parameters to use to train a machine learning model, such as an RCL model or ML model.

In some implementations, computing system 102 can include a data pipeline 120. Data pipeline 120 can integrate with one or more components of system 100 to transform data and build predictive models. Data pipeline 120 can process data from one form (e.g., a raw form) into another form. Actionable insights or predictions can be derived from the transformed data. Moreover, the data can be derived via performance of data pipeline 120 through a series of stages.

In some implementations, data pipeline 120 can select, for a given training dataset, a corresponding set of pipeline components. The pipeline components can be implemented in software, hardware, firmware, or a combination thereof. For example, the pipeline components can include including a loader, an encoder, a builder, and an inference component. Based on whether the training dataset includes text, image, tabular, or large language model data, computing system 102 can select, from a pipeline registry, a corresponding pipeline configuration through a common typed interface that binds the loader, encoder, builder, and inference component for that data type, and translate one or more configuration options into runtime parameters. These runtime parameters can be used across training, inference, and auto-optimization operations. The loader component can retrieve and normalize input data. The encoder component can generate encoded feature artifacts from the input data. The builder component can generate or update a candidate function or model using the encoded feature artifacts. The inference component can generate predictions or scores from the candidate function or model. Data pipeline 120 can further support shared caching, logging, and metric collection across multiple data types (e.g., text, images, tabular, or large language model data) such that encoded feature artifacts generated for one set of candidate parameters can be reused when evaluating another set of candidate parameters. By reusing the encoded feature artifacts, the technical solutions allow computing system 102 to reduce computations (or re-computations), saving computing resources, improving throughput, and facilitating more efficient parameter optimization and model training.

Client device 104 may refer to a computing device that accesses services and resources provided by a server (e.g., computing system 102) or a network (e.g., network 150). Client device 104 may include hardware components including processors (e.g., CPUs, GPUs, AI Accelerator chips, etc.), memory, storage, input/output interfaces, and communications systems. Client device 104 can correspond to a desktop computer, a laptop, a tablet, a smartphone, a mobile device, a wearable device, an IoT device, a headless device, or other device types, or combinations thereof. Client device 104 may execute client-side applications that interact with server-side applications to perform various tasks, such as browsing the internet, accessing email, and running software applications.

Corpus 106 may refer to one or more corpuses of data from which training data (stored in training data database 108) may be stored. The corpuses may include open source texts, crawled texts, knowledge-based texts, novels or other works of literature, image datasets (e.g., ImageNet), or other corpuses of data. In some examples, corpus 106 may include medical image databases storing images depicting various tissue samples, blood smears, or other medical images. These medical images may include labels indicating what the image depicts (e.g., images can be labeled to indicate that they include tissue samples indicative of certain diseases or are healthy tissue samples). Corpus 106 may include sources accessible via network 150. For example, Internet-based knowledge sources can be accessed by computing system 102, and corpus 106 may represent such types of resources.

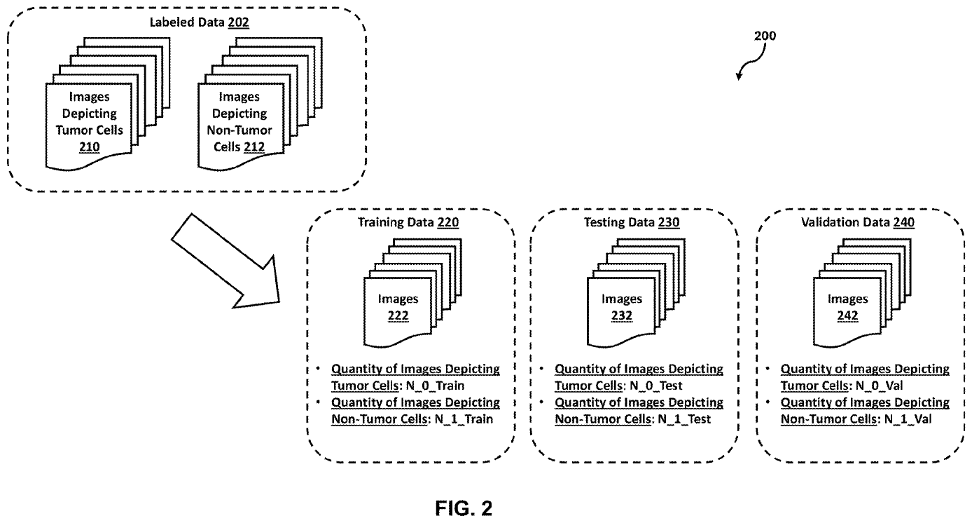

Training data database 108 may store training data samples that can be used to train, validate, or test one or more models. The training data may be curated from corpus 106. For example, portions of data included in corpus 106 may be obtained, and one or more pre-processing steps may be performed to format the data for use during training. These processes may include, for text-based data, but are not limited to, space removal, sequence preparation, character conversion, or others. For image-based data, the pre-processing steps may include, but are not limited to, resizing, grayscale conversion, noise reduction, contrast adjustment, etc. The training data samples can be stored in specific directories based on the classes of data represented (e.g., images depicting cancerous tissue, images depicting healthy tissue). In some examples, data from corpus 106 can be split into training, testing, and validation datasets. As an example, with reference to FIG. 2, system 200 depicts an example where computing system 102 may be configured to retrieve or otherwise access labeled data 202 stored by corpus 106. As mentioned above, labeled data 202 stored by corpus 106 may include a large number of images (e.g., 10⁶ or more, 10⁹ or more, 10¹² or more, etc.). In some implementations, corpus 106 can be updated, either manually or automatically. For example, computing system 102 may use a crawler functionality to crawl one or more data sources for new data samples or data sources.

In an illustrative example, labeled data 202 may include images of one or more classes. For example, labeled data 202 may include images 210 and images 212. Images 210 may include one or more images depicting tumor cells. Images 212 may include one or more images depicting non-tumor cells. In some examples, images 210 and 212 may be balanced. Other examples may include images 210 and images 212 being unbalanced. Each image (e.g., of images 210 and 212) may include associated metadata including a label indicating a class or classes with which a given image corresponds. For example, images 210 may each include metadata indicating that those images depict tumor cells (e.g., labeled with a binary flag 0) while images 212 may each include metadata indicating that those images depict non-tumor cells (e.g., labeled with a binary flag 1). For simplicity, examples may be described including two classes, however larger numbers of classes can be implemented in a similar manner (e.g., using non-binary flags). Furthermore, while images are described as labeled data 202, labeled data 202 may alternatively include text data or other data formats.

In some implementations, computing system 102 may be configured to split labeled data 202, or a portion of labeled data 202, into training data 220 including images 222, testing data 230 including images 232, and validation data 240 including images 242. While all of labeled data 202 can be split, in practice, this may consume more computational resources than needed. Therefore, a predefined portion of labeled data 202 may be selected from which training data 220, testing data 230, and validation data 240 can be created. For example, labeled data 202 may include images for tumor classification tasks, object recognition tasks, text classification tasks, etc. The splitting of the data can be random. For example, each sample included in labeled data 202 (e.g., of corpus 106) can have an equal likelihood of being placed in training data 220, testing data 230, or validation data 240. In some implementations, the splitting between training data 220, testing data 230, and validation data 240 may be 70/20/10, 80/10/10, 80/5/15, or others.

In some implementations, training data 220, testing data 230, and validation data 240 may be stored in training data database 108. Training data 220, testing data 230, and validation data 240 may be logically partitioned within training data database 108 to prevent selecting from the wrong grouping. In some implementations, validation data 240 can be omitted from a given auto-optimization run and reserved for downstream model training, threshold calibration, post-selection validation, or other downstream tasks, or combinations thereof. Moreover, separate training, testing, and validation datasets can be maintained throughout the auto-optimization process.

In some implementations, computing system 102 may be configured to determine a total number of images included within each of training data 220, testing data 230, and validation data 240 for each class. For example, training data 220 may include images 222. Of images 222, N_0_Train of the images may depict tumor cells, whereas N_1_Train of the images may depict non-tumor cells. Testing data 230 may include images 232, of which N_0_Test may depict tumor cells and N_1_Test may depict non-tumor cells. Validation data 240 may include images 242, of which N_0_Val may depict tumor cells and N_1_Val may depict non-tumor cells.

Persons of ordinary skill in the art will recognize that images 222, 232, and 242, may differ in volume, type, quantity, distribution, or in other ways. In some examples, N_0_Train, N_0_Test, and N_0_Val, as well as N_1_Train, N_1_Test, and N_1_Val may be substantially similar to one another, however that is not required. For example, N_0_Train may be greater than N_0_Test, while N_1_Train may be smaller than N_1_Val.

Returning to FIG. 1, RCL model 110 refers to a model or a set of models trained using an RCL process described herein. RCL model 110 is illustrated as a single model, however additional models may be included. ML model 112 refers to a model or set of models trained on one or more non-RCL-based processes. For example, ML model 112 may represent a large language model (LLM) trained using GPU-based computing stacks, a transformer neural network (TNN), or other deep-learning model.

In some implementations, RCL-based models, such as RCL model 110, may implement a shared-nothing architecture. In such architectures, each process can operate independently without shared memory, further enhancing scalability. Share-nothing architectures generally include distributed computing models, where each node (or system) operates independently, with its own local memory, storage, and processing power. No direct sharing of data or memory between nodes may be used, meaning each node is responsible for its own subset of the data and processing tasks. The nodes can communicate, however, with communications occurring through network connections, and data being explicitly transferred from one node to another. Shared-Nothing or Big Data architectures can be used with large-scale distributed systems, such as cloud computing platforms, databases (e.g., NoSQL), big data processing frameworks (e.g., Hadoop, Spark), and the like. In some implementations, ML models, such as ML model 112, may implement share-based architectures.

In some implementations, computing system 102 can train a prediction model, such as RCL model 110. In some implementations, to train the prediction model, parameters for training may be determined. Optimizing those parameters, and the values or tunings assigned to those parameters for the training process, can improve the overall training process, reducing the time it takes to train as well as increasing the accuracy of the model. This is particularly important for RCL-based models, which can include diverse datasets.

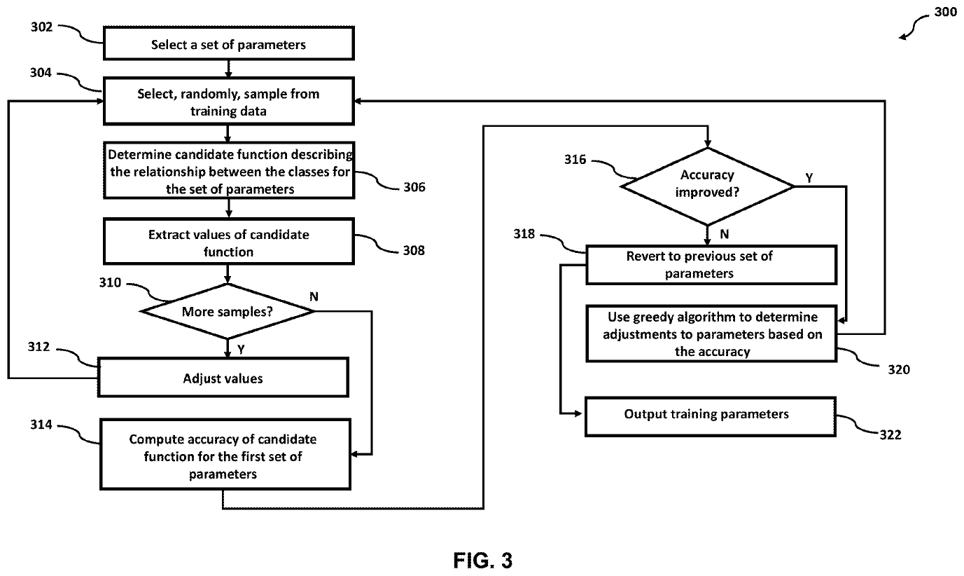

In some implementations, computing system 102 may be configured to implement an auto-optimization process to determine a set of parameters that facilitates the most efficient and accurate training of a model (e.g., RCL model 110, ML model 112). As an example, with reference to FIG. 3, process 300 describes aspects of an example auto-optimization process that can be used to determine the set of parameters. The auto-optimization process configures computing system 102 such that it will adjust various parameters and settings to achieve the highest possible accuracy in its predictions. This feature is beneficial for users who require precise and reliable results, as it facilitates that the model is fine-tuned to deliver optimal performance.

As mentioned above, the auto-optimization process may begin by splitting the labeled training samples (e.g., labeled data 202 of FIG. 2) into training data (e.g., training data 220), testing data (e.g., testing data 230), and validation data (e.g., validation data 240). While the foregoing description refers to the training samples being images, other data formats can be used, such as text, video, audio, and the like. As an illustrative example, the labeled training samples may include images depicting tumor cells and images depicting non-tumor cells. Each training sample may be labeled to include the class of data with which it belongs (i.e., class of images depicting tumor cells, class of images depicting non-tumor cells). For example, if the labeled data includes images X having labels L, then the data may be represented as {Image X1, Label L1}, {X2, L2}, . . . , {XN, LN}}, where L=0 indicating the image depicts tumor cells, or L=1 indicating that the image does not depict tumor cells).

In some implementations, as mentioned above, the labeled data can be split into training data, testing data, and validation data (e.g., training data 220, testing data 230, validation data 240 of FIG. 2). The training data refers to the data to be used by the auto-optimization process (e.g., process 300) to learn relationships between the depicted (two) classes (e.g., images depicting tumor cells, images not depicting tumor cells). Candidate functions describing the relationship between the depicted classes can be determined using the auto-optimization process. These candidate functions, which are also referred to herein interchangeably as “models” or “model descriptions,” can be tested using the testing data. The testing data can be used to test the accuracy of the candidate function. The validation data can be used to train a downstream model (e.g., an LLM) and can remain unused during the auto-optimization process. For simplicity, the validation data can be excluded from process 300 and reserved for downstream model training, threshold calibration, post-selection validation, or other downstream operations, or combinations thereof. Thus, the corpus of data selected for the auto-optimization process can be split into training and testing (e.g., 70/30, 75/25, 80/10, etc.).

In some implementations, the training dataset can be split into a learning set and a testing set. The learning set can be further split into a first subset of data items having the first label and a second subset of data items having the second label. The testing set can be split into a third subset of data items having the first label and a fourth subset of data items having the second label. As an example, the learning set can include a first subset of training images having a first label (e.g., that image depicts tumor cells) and a second subset of training images having a second label (e.g., that image does not depict tumor cells). In some implementations, the accuracy metric can be computed based on the testing set. After the training, testing, and validation datasets have been split (and the validation datasets set aside), the total number of images included in each class can be determined by computing system 102. For example, where the labeled images depict tumor cells (e.g., labeled with L=0) or images not depicting tumor cells (e.g., labeled with L=1), two quantities can be determined for both the training data (e.g., N_0_Train, N_0_Test) and the testing (e.g. N_1_Train, N_1_Test). A similar process can also be performed for the validation set (e.g., splitting into one subset of data items labeled with the first label and another subset of data items labeled with the second label).

In some implementations, process 300 may begin at step 302. At step 302, a set of parameters (P1) may be selected. This set of parameters (P1) may refer to a first set of parameters, which will be tested to determine whether this set is to be used for training a model using a given set of training data. Some example evaluation methods include, but are not limited to Chi-Squared, Fractals, Naïve Bayes, Chi-Squared Pair, Naïve Bayes Pair, SoftMax, SoftMax Pair, or others.

Chi-Squared refers to an example evaluation method where all patterns are evaluated assuming that the null hypothesis (i.e., all patterns are random) is true. The class (e.g., images that depict tumor cells, images that do not depict tumor cells) that deviates the most from the random assumption can then be identified (e.g., using computing system 102). This can indicate the class with the most statistical difference, meaning that this class deviates the most from the random distribution.

Fractal refers to an example evaluation method that evaluates patterns by measuring their deviation from a Probability Density Function (PDF) that assumes self-similarity, a fundamental characteristic of fractals. In this approach, patterns in the data are compared against an expected fractal-based distribution, assessing how well they conform to a structure that exhibits repeating patterns at different scales. The method calculates the Sum Squared Error (SSE) between the observed patterns and the expected fractal-based distribution, quantifying the degree of deviation. The class with the lowest SSE, which can indicate the closest match to the self-similarity assumption, wins as it represents the classification that most-closely aligns with the fractal model. This technique is particularly useful in image analysis and natural pattern recognition, where fractal characteristics frequently emerge in real-world data.

Naïve Bayes refers to another example evaluation method that evaluates all patterns under the assumption that features are independent of each other, using randomness as the baseline for comparison across all classes. Naïve Bayes calculates the probability of each class given the observed features, contrasting each class against the assumption of randomness in the data distribution. The model assigns probabilities to different possible classifications, determining which class has the strongest statistical deviation from the others. The class that exhibits the greatest deviation, or “pull,” from the expected probabilities of other classes is considered the most likely classification and is thus selected as the “winning” class. This approach allows Naïve Bayes to efficiently classify data, even in cases where the independence assumption is not perfectly met.

Chi-Squared Pair refers to an example evaluation method that is an extension of traditional Chi-Squared evaluations to handle multi-class classification problems involving three or more classes. Instead of analyzing all classes simultaneously, Chi-Squared Pair evaluates patterns in a pairwise manner, comparing two classes at a time to determine which provides the best fit. This approach allows for a more granular assessment of how each class deviates from the expected randomness, ensuring that subtle differences between classes are captured. By systematically examining every possible class pair, Chi-Squared Pair can identify strong statistical deviations and determine an appropriate classification. Ultimately, the class that consistently shows the most significant pull away from randomness across multiple pairwise comparisons is considered the “best” fit, which can improve classification accuracy in complex multi-class scenarios.

Naïve-Bayes Pair refers to an example evaluation method that is an extension of traditional Naïve Bayes approaches to handle multi-class classification problems involving three or more classes. Instead of evaluating all classes simultaneously, Naïve-Bayes Pair operates by comparing two classes at a time in a pairwise fashion. By assuming independence among features and using Bayes' theorem, Naïve-Bayes Pair can calculate the probability of each data point belonging to one of the two compared classes. This pairwise evaluation allows for a more refined analysis of class distinctions, as it isolates comparisons to determine which class provides the best probabilistic fit for a given data point. By systematically assessing all possible class pairs, Naïve-Bayes Pair can ensure that each pattern is assigned to the class with the strongest statistical pull away from the others. Naïve-Bayes Pair approaches also enhance classification accuracy by breaking down complex multi-class problems into more manageable, focused comparisons, ultimately leading to more reliable decision-making in diverse datasets.

SoftMax refers to an example evaluation method in classification tasks that transforms a model's raw output scores, or logits, into a structured probability distribution. This transformation is achieved by applying the SoftMax function, which exponentiates each logit and normalizes it by dividing by the sum of all exponentiated logits, ensuring that the outputs represent probabilities that sum to one. By doing so, SoftMax allows for a clear comparison between class probabilities, making it possible to interpret the model's confidence in each prediction. In evaluation, SoftMax is particularly useful because it enables ranking the predicted class probabilities and selecting the class with the highest probability as the most likely outcome. Additionally, this probability-based assessment allows for further analysis, such as measuring classification confidence, identifying ambiguous cases, and even calibrating model outputs to improve decision-making. As a result, SoftMax can play an important role in refining and validating classification models, helping to ensure that predictions align with probabilistic reasoning and aiding in assessing model performance across different datasets.

SoftMax Pair refers to another example evaluation method designed for multi-class classification problems involving three or more classes, extending the principles of the SoftMax function. Rather than evaluating all classes simultaneously, SoftMax Pair operates by comparing classes in a pairwise manner, determining the best fit between two classes at a time. This approach enables a more granular analysis of class probabilities by isolating comparisons, making it particularly useful for identifying subtle distinctions between closely related categories. By applying the SoftMax function separately to each pair, SoftMax Pair can ensure that probability distributions remain normalized while allowing for a more detailed evaluation of how individual classes compete against one another. The class that consistently emerges with the highest probability across multiple pairwise comparisons can be deemed the most likely outcome. Thus, SoftMax Pair can enhance classification accuracy in complex datasets where multiple classes may share overlapping characteristics, ultimately improving model reliability by systematically refining predictions through step-by-step comparisons.

Additional parameters possible include scaling parameters, such as box-down, RCL ticks, or others. In some implementations, the set of parameters can include a downscaling parameter. For example, box down refers to a method of reducing the size (downscaling) of an image for image processing. Box down functions by averaging pixel values within a defined box-shaped region to create lower-resolution versions of an image while preserving as much detail as possible. In some implementations, computing system 102 can select one or more dimensions for a box-shaped region within a sample image. Computing system 102 can apply the downscaling parameter included within the set of parameters to the image to reduce an image resolution of the sample image. In some implementations, the image resolution can be reduced based on averaging pixel values within the box-shaped region. As an illustrative example, in a 2×2 box down-sampling, each group of four adjacent pixels in an original image is averaged to produce a single pixel in the down-sampled image. This helps smooth the image and reduce artifacts. Moreover, a larger box (e.g., 3×3, 4×4) can be used for greater reduction.

In some implementations, the set of parameters can include a discretization parameter. Computing system 102 can select the set of parameters including the discretization parameter by mapping byte values into a predefined range of symbols. By mapping the byte values into the predefined range of symbols, computing system 102 is able to compress the data item to be processed (e.g., the sample image). For example, RCL ticks can represent an example discretization parameter. RCL ticks can discretize a byte into a letter, effectively compressing data by converting numerical values into a predefined range of characters. For instance, with RCL ticks set to 10, the numbers 0 to 255 can be mapped to a range of letters ABCDEFGHIJ. Therefore, discretization parameters, such as RCL ticks, can be applicable to both text-type and image-type datasets, allowing those datasets to be simplified and encoded into a more manageable, lower size, format.

As an illustrative example, the first set of parameters (e.g., P1), can include the evaluation method being Naïve Bayes (e.g., Eval=Naïve_Bayes). In some examples, the first set of parameters may include an initial set of values for other parameters, such as a value for the box down sampling (e.g., Box_Down=2×2), a value for RCL ticks (e.g., RCL_Ticks=32).

In some implementations, selecting the set of parameters can include computing system 102 applying a flag to the candidate function. The flag being applied to the candidate function can trigger a collapse of one or more patterns having a pattern frequency that is less than a threshold pattern frequency. The patterns can be collapsed into one pattern. That one pattern can be incorporated into the candidate function. In an example, the flag can be applied to one or more of the aforementioned evaluation methods to designate those evaluation methods as “imaginary.” When the imaginary flag is applied to an evaluation method, computing system 102 may be configured to trigger a collapse of low-frequency patterns into an imaginary pattern. This imaginary pattern may then be incorporated into the selected evaluation method. One technical benefit effectuated by using the imaginary flag is that it can lead to smaller models with faster inference times, depending on the data being processed. This optimization is particularly useful in scenarios where computational efficiency is critical, as it reduces the complexity of the model without compromising its performance. For example, computing system 102 can apply a flag that treats patterns detected within the training data samples (e.g., within one or more images) less than a threshold quantity of times (e.g., less than 10 instances of that pattern was detected, less than 5 instances, etc.) as part of a shared “rare pattern” category. By grouping those flagged patterns in one group instead of in separate groups, each associated with one of the detected “rare” patterns, and using that one group for the candidate function, the machine learning model has fewer distinct patterns to store, compare, evaluate, or process. By reducing the number of “rare” patterns, the model's complexity can be reduced while the training time and response latency during inference operations can be improved.

In some implementations, computing system 102 can evaluate a first plurality of sets of candidate parameters for the candidate function. The first plurality of sets of candidate parameters can be evaluated using a first portion of the training dataset. Computing system 102 can identify one or more sets of candidate parameters from the first plurality of sets of candidate parameters based on those sets of candidate parameters having a performance score that is less than a lower bound threshold. Computing system 102 can remove some or all of the sets of candidate parameters identified as having a performance score less than the lower bound threshold from the first plurality of sets of candidate parameters to obtain a second plurality of sets of candidate parameters. In this example, the second plurality of sets of candidate parameters includes fewer sets of candidate parameters than the first plurality of sets of candidate parameters. Computing system 102 can evaluate the second plurality of sets of candidate parameters using a second portion of the training dataset. The second portion of the training dataset can refer to a different portion of the training dataset than the first portion of the training dataset. Moreover, the second plurality of sets of candidate parameters can have a greater quantity of samples than the first plurality of sets of candidate parameters. In some implementations, the set of parameters selected include selecting one or more of the second plurality of sets of candidate parameters. For example, computing system 102 can test 10 different training setups on a small part of a training dataset to identify, quickly, which setups perform poorly. Computing system 102 can remove those setups having scores below a threshold while retaining one whose performance score is greater than or equal to the threshold. Those remaining setups can be tested by computing system 102 on a larger, different portion of the training dataset, thereby obtaining a more reliable result and increasing the likelihood of an optimal set of candidate parameters being selected.

In some implementations, the evaluation of the candidate parameters can be performed as a successive-halving process. For example, computing system 102 can evaluate the first plurality of sets of candidate parameters using a first fraction of the training dataset, such as a relatively small fraction selected to reduce computational cost in an initial screening round. Based on the resulting performance scores, computing system 102 can retain a survivor subset including the highest-performing set of candidate parameters and eliminate lower-performing set of candidate parameters. The survivor subset, including a second plurality of sets of candidate parameters, can include approximately one-half of the set of candidate parameters evaluated in the immediately preceding round. Computing system 102 can evaluate the second plurality of sets of candidate parameters on a larger fraction of the training dataset in a subsequent training round. Computing system 102 can repeat this process for multiple rounds. For example, computing system 102 can select a larger fraction of the training dataset for each round as compared to the previous round. Moreover, each round can reduce the number of sets of candidate parameters that survive. In some implementations, computing system 102 can continue evaluating until a single set of candidate parameters, until fewer than a threshold number of sets of candidate parameters remain, or until a performance threshold or stopping condition is satisfied.

In some implementations, the fractions of the training dataset can be increased monotonically across rounds. For example, from a first fraction to a second fraction to a third fraction, the third fraction can be created such that it includes more samples than the second fraction, and the second fraction can be created such that it includes more samples than the first fraction. In this way, evaluation of the various sets of candidate parameters can be performed quicker, discarding weaker sets of candidate parameters, while more computationally expensive evaluations, and corresponding pipeline components, can be reserved for stronger set of candidate parameters.

In some implementations, selecting the set of parameters can include computing system 102 identifying less than a threshold quantity of sets of candidate parameters within the second plurality of sets of candidate parameters that have respective performance scores less than a first threshold. Computing system 102 can select a set of candidate parameters from the second plurality of sets of candidate parameters having respective performance scores greater than or equal to a second threshold. The set of parameters selected can include some or all of the parameters from the set of candidate parameters. For example, after testing several training setups, computing system 102 can identify that less than a threshold number of training sets still produce performance scores that are less than a lower bound score (e.g., a training setup for a model producing an accuracy less than 75%), indicating that most of the weak options for training setups have been filtered out. Computing system 102 can choose one of the remaining training setups that meets or exceeds an upper bound score (e.g., a training setup for a model producing an accuracy above 90%). That training setup selected can be used for the machine learning model to be trained.

In some implementations, identifying the one or more sets of candidate parameters can include computing system 102 calculating a quantity of sets of candidate parameters included by the first plurality of sets of candidate parameters. Based on the quantity of sets of candidate parameters that were calculated, the lower bound threshold can be tuned such that the sets of candidate parameters include at least half of the first plurality of sets of candidate parameters. As an example, initially, computing system 102 can retrieve, access, generate, or otherwise obtain an initial collection of training sets, such as 20 different training setups. Computing system 102 can additionally receive or be programmed to have a threshold to remove training setups that are weaker (e.g., have a performance score that is less than a lower bound threshold), such that the remaining 10 setups after removal of the weaker ten represent the strongest performing sets. If, however, computing system 102 initially began with 8 setups, the lower bound threshold can be adjusted so that fewer setups are filtered out (e.g., at least 4 are filtered out). As a result, computing system 102 can reduce the list of sets of candidate parameters by about half each round, keeping the better options and dropping the weaker ones.

In some implementations, computing system 102 can select a set of candidate parameters from the second plurality of sets of candidate parameters. Computing system 102 can select the set of candidate parameters based on a corresponding performance score associated with the set of parameters being greater than or equal to a first threshold. Computing system 102 can store the set of candidate parameters after selection. The set of candidate parameters can be stored in memory of computing system 102. Alternatively, or additionally, the set of candidate parameters can be stored in a database or other storage device for later use. The optimal set of training parameters, for example, can include the set of candidate parameters. For example, after testing the remaining training setups, computing system 102 can determine that one training setup produced an accuracy score above a threshold accuracy level (e.g., 75% or greater, 85% or greater, 90% or greater, etc.). Computing system 102 can save that training setup in training data database 108 for use later to train the final model (e.g., RCL model 110, ML model 112, or another model). This can reduce time to select the parameters to be used as the saved candidate parameters can be used as the selected training parameters.

In some implementations, the set of parameters includes a first set of candidate parameters. Computing system 102 can cache one or more encoded feature artifacts of the training dataset for the first set of candidate parameters. Computing system 102 can evaluate a second set of candidate parameters using at least one of the encoded feature artifacts. An encoded feature artifact refers to a reusable, machine-readable version of information that has been extracted from the training dataset after the training dataset has been processed under a particular set of candidate parameters (i.e., a training setup). In an example, the encoded feature artifacts can be cached in memory or storage accessible to computing system 102, such as local memory, disk, cloud storage, or cache of training data database 108). By caching the encoded feature artifacts, later sets of candidate parameters can reuse that encoded feature artifacts instead of having to recompute them. Encoded feature artifacts can be of a variety of types depending on a type of data included within the training dataset. For example, if the training dataset includes text, some example encoded feature artifacts can include, but are not limited to, tokenized text, ordered n-gram features, joined token representations, hashed pattern counts, directional sequence encodings, or combinations thereof. As another example, if the training dataset includes images, some example encoded feature artifacts can include, but are not limited to, resized image data, down-scaled (e.g., box-down) image data, grayscale-transformed pixels, compressed pattern maps, edge/texture descriptors, or encoded pixel blocks generated using a selected box size or RCL tick setting, or combinations thereof. As yet another example, if the training dataset includes tabular data, the encoded feature artifacts can include, but are not limited to, normalized columns, bucketed values, categorical encodings, or compressed feature vectors, or combinations thereof. These encoded feature artifacts represent intermediate encoded features already prepared for one set of candidate parameters and then cached so computing system 102 can test another set of candidate parameters more quickly.

At step 304, computing system 102 may be configured to select, randomly, a sample from the training data. For example, computing system 102 may select a first image (e.g., X1) having a first label (e.g., L1) from images 222 of training data 220. This process is important in ensuring that the model will be exposed to a diverse set of examples, enhancing its ability to generalize and perform accurately on unseen data. As mentioned above, the images from which the sample is selected may include images that have been classified into a particular class (or classes). For simplicity, examples including two classes are described, however additional classes may be used.

As an illustrative example, where images 222 of training data 220 represent digital pathology images, each image may include a label indicating whether that image depicts tumor cells (e.g., a tissue sample labeled as including, or including a threshold amount or more of, malignant tumor cells) or does not depict tumor cells (e.g., a tissue sample labeled as not including, or including less than a threshold amount of, malignant tumor cells). These labels can be represented as binary labels: if an image Xi depicts tumor cells, it is assigned a first label (e.g., L=0), and if an image Xi does not depict tumor cells, it is assigned a second label (e.g., L=1). In the context of digital pathology images, for example, computing system 102 may randomly select an image of a tissue sample that has already been labeled.

At step 306, computing system 102 may determine a candidate function for the first set of parameters (P1). The candidate function represents a mathematical and functional description of the relationships between different classes of data included within the training data. The candidate function, which can also be considered a model, when tuned, should be able to predict, for a given data sample, whether that sample should be classified into one class or the other class. As a simple and illustrative example, the candidate function may be: y=mx+b, where m and b are the parameters to be determined. The candidate function should fit the training data such that, given an input sample (e.g., “x”), the candidate function can determine the class (e.g., “y”). In the example of digital pathology images, the candidate function will include parameters that describe the relationship between the classes (e.g., images depicting tumor cells, images not depicting tumor cells). As another illustrative example, the parameters selected may include Naïve Bayes being chosen as the evaluation method. For example, using the Naïve Bayes, which for the randomly selected sample, can determine the likelihood that the sample is in either class. In practical implementations, however, the candidate function may correspond to a scoring function, classifier, RCL-based pattern structure, or other model configuration defined by one or more selected evaluation, preprocessing, or optimization parameters. In other words, the above-mentioned linear example represents a simplified abstraction.

At step 308, computing system 102 may be configured to extract values of the candidate function. For example, values associated with the parameters can be determined based on the input sample. Using the linear example above, the extracted values (e.g., V1) may represent the (m, b) fit to the training data sample (e.g., V1=(m1, b1)). In some implementations, computing system 102 can compute or update one or more statistics associated with some or all of the parameters, learned quantities, score values, feature values, intermediate model values (e.g., generated under a set of candidate parameters), or other statistical measures, or combinations thereof.

At step 310, computing system 102 can determine whether any more samples from the training data are to be analyzed. For example, process 300 may iterate a predefined number of times (e.g., 10² or more iterations, 10³ or more iterations, 10⁴ or more iterations, etc.), corresponding to a predefined number of samples that are to be analyzed. If, at step 310, computing system 102 determines that more samples are to be analyzed, process 300 may proceed to step 312. However, if at step 310 computing system 102 determines that no more samples are to be analyzed, process 300 may proceed to step 314.

As mentioned above, step 312, computing system 102 may be configured to determine one or more adjustments to make to the candidate function based on a computed loss. In some implementations, one or more values from the set of parameters can be adjusted based on a loss. The loss can be computed using the predicted label for the sample image and a ground truth label for the sample image. The ground truth label can include the first label or the second label. For example, computing system 102 can determine a difference between the predicted label and the actual label (e.g., the training image is actually labeled as showing tumor cells, but the candidate function predicts that it does not). This loss represents the difference. Based on that loss, computing system 102 can modify a value of one or more parameters so the candidate function is more likely to make the correct prediction next time.

As an illustrative example, the adjustments to the candidate function may include adjusting the previously used values (V1) for the selected parameters (P1). In some implementations, the loss may be computed based on a difference between the sample's label and a predicted label (for the candidate function). As an example, the candidate function (e.g., y=mx+b), given parameters P1 (m, b) having values V1 (m1, b1), may determine, for a given sample X1, a predicted label y=Y1. Computing system 102 can determine whether the predicted label Y1 equals the known label associated with sample X1 (e.g., label L1). The adjustments made to values V1 for parameters P1 can be made based on the difference (if any) between label L1 and predicted label Y1. For example, if L1≠Y1, computing system 102 may adjust values V1 (e.g., m1→m2, b1→b2) to try and improve the candidate function's ability to predict, for the given set of parameters P1, the label for a given training sample. If, however L1=Y1, computing system 102 may adjust values V1 differently, less, or not at all, to help reinforce that the candidate description (for the given set of parameters P1 and values V1), was able to predict the correct label for the sample image.

In some implementations, process 300 may return to step 304 after step 312. For example, after the adjustments to the values of the selected parameters have been implemented, computing system 102 may select, randomly, another sample from the training data. For instance, computing system 102 may select an image X2, having label L2, from images 222 of training data 220.

At step 314, computing system 102 may be configured to compute an accuracy of the candidate function. For example, the accuracy can be computed for the first set of parameters (P1). For a given test sample, computing system 102 may be configured to predict, using the candidate function, whether the sample belongs to the class of images depicting tumor cells or the class of images depicting non-tumor cells. This prediction can then be compared to the ground truth label, using the selected accuracy metric, to determine the accuracy of the candidate function.

In some implementations, computing system 102 can compute the accuracy of the candidate function by calculating a balance score. The balance can represent how balanced the training dataset is with respect to the first label and the second label. For example, the balance score can be computed based on a ratio of a quantity of samples included in the training dataset that have the first label (e.g., image depicting tumor cells) or the second label (e.g., image not depicting tumor cells). The accuracy metric selected to compute the accuracy of the candidate function can be selected from amongst a plurality of accuracy metrics based on the balance score. For example, computing system 102 can count how many training samples are included in the training dataset that include a first label (e.g., the image depicts tumor cells) and how many training samples are included in the training dataset that have a second label (e.g., the image depicts non-tumor cells). If the counts are close (e.g., within 5% of one another, within 10% of one another, within 15% of one another, etc.), computing system 102 can treat the training dataset as being balanced and select an accuracy measure based on the similarity in balance between the two counts. If one label appears much more often than the other within the training dataset (e.g., more images depicting non-tumor cells than tumor cells, or vice versa), computing system 102 can select a different metric. For example, if there is an imbalance between the different classes in the training dataset, an accuracy metric, such as F1 score, can be selected.

In some implementations, computing system 102 may be configured to select an accuracy metric. Selecting the accuracy metric may include an initial determination by computing system 102 of a number of distinct classes described by the data. For example, if the testing data (and training data) included samples labeled into one of two classes, computing system 102 may select Overall Accuracy (acc) as the accuracy metric. If computing system 102 determines that the testing data (and training data) are reasonably balanced, computing system 102 may be configured to select a different accuracy metric, such as the Macro Average F1 Score (af1). Furthermore, if computing system 102 determines that the testing data (and the training data) are imbalanced, computing system 102 may be configured to select the Weighted Average F1 Score (wf1) as the accuracy metric.

The choice of evaluation method is crucial in determining the effectiveness of a model, as it directly impacts the performance metrics used to assess its accuracy and reliability. The available methods—accuracy (acc), weighted F1 score (wf1), average F1 score (af1), and Matthews correlation coefficient (mcc)—each offers a unique perspective on model evaluation, and the selection of one over another can significantly influence the results. For instance, maximizing accuracy focuses on the overall correctness of predictions, while optimizing the average F1 score emphasizes balanced performance across all classes, ensuring comprehensive coverage. This distinction becomes particularly important when there is a skew in the distribution of classes or predictions, as the choice of evaluation method can affect how well the model handles imbalanced data and provides meaningful insights.

Moreover, dataset balance refers to the distribution of data samples across all classes. For instance, a two-class dataset with 100 samples in the first class and 94 samples in the second class is considered reasonably balanced. However, if the second class contains only 58 samples, the dataset may be deemed imbalanced.

Persons of ordinary skill in the art will recognize that the term “accuracy metric” and “performance metric” are used herein interchangeably.

In some implementations, computing system 102 may be configured to receive a selection of the auto-optimization parameter associated with specific accuracy metrics. For example, these selections may be passed in the following formats:
auto-optimize=acc: The system pursues overall accuracy.
auto-optimize=af1: The system pursues Macro Average F1 Score.
auto-optimize=wf1: The system pursues Weighted Average F1 Score.
auto-optimize=mcc: The system pursues Matthews Correlation Coefficient.

In some implementations, by enabling the accuracy metric to be selected and varied, computing system 102 is able to allow for flexibility in optimizing performance based on the desired metric and the characteristics of the dataset.

In some implementations, the set of parameters can include a directional parameter. Computing system 102 can use the directional parameter while executing process 300. The direction parameter may be designed to maintain the order of features in a data sample. For example, the directional parameter can preserve an order that features are extracted from each sample image, or other data type. The directional parameter can be particularly useful when working with text and image data, as the sequence of features can be crucial for accurate analysis and interpretation. By preserving the order of features, the algorithm ensures that the contextual relationships within the data are maintained, leading to more reliable and meaningful results.

The directional parameter may not affect tabular data. For example, in tabular data, the order of features is typically less significant, as each feature is treated independently. Therefore, the directional parameter can be tailored for scenarios where the sequence of features plays a vital role in the evaluation process. Inclusion of the directional parameter imparts greater flexibility and control over the data analysis, allowing more precise and accurate outcomes to be achieved.

At step 316, computing system 102 may be configured to determine whether the accuracy improved with respect to a previously computed accuracy. In some implementations, determining whether the accuracy improved can include determining whether a performance criterion has been satisfied. For example, the performance criterion being satisfied may include a modification of the plurality of configuration parameters not increasing the performance, the performance comprising at least one of an accuracy, a recall, a precision, or an F-score.

In an example implementation, the set of parameters can include a first set of parameters and the accuracy of the candidate function can include a first accuracy. In this example implementation, computing system 102 determining that the accuracy satisfies the performance criterion can include modifying one or more parameters of the first set of parameters. For example, a second set of parameters can be generated. The second set of parameters can include fewer parameters, more parameters, a same quantity of parameters, or different types of parameters, or other permutations and variations., as compared to the first set of parameters. Computing system 102 can compute a second accuracy of the candidate function using the accuracy metric based on the second set of parameters. The second accuracy of the candidate function can be determined for the second set of parameters. If the second accuracy of the candidate function is determined to be less than the first accuracy of the candidate function, computing system 102 can discard or otherwise adjust the second set of parameters, or revert back to the first set of parameters. For instance, the second accuracy of the candidate function for the second set of parameters being less than the first accuracy of the candidate function for the first set of parameters can indicate that the modifications to the parameters of the first set of parameters failed to improve the accuracy of the candidate function. As an illustrative example, computing system 102 can test a first training setup that includes using Naïve Bayes, a 2×2 box-down setting, and 32 RCL ticks. Computing system 102 can determine that, for the test of the first training setup, the first accuracy score was computed to be 91%. Computing system 102 can modify one or more of the parameters, such as using SoftMax function or a different box-down value, and test the candidate function with the modified (e.g., second) training setup. For instance, computing system 102 can determine that the second training setup produced a second accuracy score of 88%. Therefore, computing system 102 can select the first training setup because the first accuracy score is greater than the second accuracy score.

In some implementations, computing system 102 can determine whether the performance criterion has been satisfied by calculating an accuracy change from a previous iteration. If the accuracy change is determined to be larger than a threshold accuracy change, then this can indicate that the accuracy is a maximum accuracy. For example, computing system 102 can test a first training setup and compute a first accuracy score (e.g., Score=92.0% accuracy) and test a second training set and compute a second accuracy score (e.g., Score=92.1%). Computing system 102 can set the threshold accuracy change to be less than a 0.5% improvement to stop iterations. Thus, because the difference in accuracy between the first accuracy score and the second accuracy score is less than the threshold accuracy change (e.g., 0.1% is less than the 0.5% threshold), computing system 102 can stop iterating for new training setups. The optimal setup has likely been identified based on the accuracy being less than a threshold accuracy (e.g., greater than 75% accuracy, greater than 85% accuracy, greater than 90% accuracy, etc.), reinforcing that further changes to the training setup likely fail to provide any significant improvements in accuracy and could potentially decrease the accuracy.

In some implementations, computing system 102 may determine whether any previous iterations of process 300 occurred, if so, the corresponding parameters and accuracy score associated with the most recent iteration. If no previous iterations have occurred (i.e., the first execution of process 300), computing system 102 may be configured to proceed to step 320. In some implementations, the performance criterion being satisfied may include an improvement in accuracy, computed using the selected accuracy metric, increasing by at least a threshold amount with respect to the most recent iteration's accuracy score. For example, if the previous iteration's accuracy score is A1 and the current iteration's accuracy score is A2, then computing system 102 may classify accuracy score A2 as an improvement if A2 is at least D more than A1.

If, at step 316, computing system 102 determines that the accuracy has not improved, process 300 may proceed to step 318. However, if computing system 102 determines that, at step 316, the accuracy has improved, process 300 may proceed to step 320.

At step 318, the previous set of parameters used during a previous iteration of process 300 (e.g., corresponding to a previous “best” accuracy score) can be retrieved. The previous set of parameters that are retrieved can correspond to a set of parameters identified during the auto-optimization process as being best performing. The previous set of parameters can be any previously created set of parameters, and does not have to be an immediately preceding iterations set of parameters. For example, proceeding to step 318 may indicate that a previously computed set of parameters had a greater accuracy score as compared to the accuracy score computed at step 314. In some implementations, computing system 102 can store, maintain, or other access a set of candidate parameters determined beforehand to be an optimal set of candidate parameters based on multiple iterations or rounds of the auto-optimization process. As an example, the optimal set of candidate parameters can correspond to the set of candidate parameters having the highest performance score, highest accuracy metric value, or otherwise best objective value observed up to a given time. If a later iteration, later round, or modified set of candidate parameters fails to improve upon the objective value associated with the optimal set of candidate parameters, computing system 102 can roll back to and preserve the optimal set of candidate parameters for output and later model training. In some implementations, rollback can be not limited to a set of candidate parameters from the immediately preceding iteration. Rather, computing system 102 can execute the rollback operation to restore any previously stored sets of candidate parameters that achieved the best objective value across the entire auto-optimization process. By executing the rollback operation to restore a previously stored set of candidate parameters, computing system 102 can prevent a later regression from displacing a superior, and earlier-discovered, configuration.

After step 318, process 300 may proceed to step 322. At step 322, computing system 102 may be configured to output training parameters. The training parameters may include the values extracted and determined to provide the improved accuracy. For example, in this step, the output may correspond to the previously computed set of parameters, which produced a greater accuracy score. In some implementations, computing system 102 may provide the set of parameters (and values for those parameters) to a model training system to train a subsequent model (e.g., RCL model 110, ML model 112) using those parameters and the training data.

In some implementations, process 300 can include steps that leverage some or all of the training parameters output at step 322. For example, computing system 102 can train the candidate function to learn one or more patterns using the training parameters. The learned patterns can be used for generation of predictions (e.g., using RCL model 110, ML model 112, or another model). Computing system 102 can store the patterns and the accuracy of the candidate function as model metadata with the training parameters. In some implementations, computing system 102 can train a refinement model (e.g., an instance of ML model 112) using outputs of the one or more patterns. Training the refinement model can be used to obtain a set of weights added to the model metadata. The set of weights can be used to refine a classification output based on the patterns. As an illustrative example, computing system 102 can train the candidate function to recognize patterns in medical images, such as shapes or textures linked to tumor cells. Computing system 102 can save those learned patterns as metadata, including the model's accuracy score, the training settings, or other information. Computing system 102 can train a second, smaller refinement model to learn how to fine-tune the first model's output. The set of weights, which can be referred to as refinement weights, can be stored too so later predictions can be adjusted more accurately. For example, saving the refinement weights lets computing system 102 to reuse learned correction rules during inference to fine-tune an initial prediction based on the detected patterns.

In some implementations, model metadata can include serialized artifacts selected from learned patterns, encoded feature artifacts, context hashes, context contribution values, residual telemetry values, refinement-head parameters, candidate-parameter selections, runtime hyperparameters, evaluation scores, or lineage information identifying the pipeline and registry entry used to generate the model, or other information, or combinations thereof.

For example, for a text input, the context features can include ordered neighboring tokens, retrieved knowledge indicators, or hashed co-occurrence patterns, or combinations thereof. Each of these context feature can be associated during training with a contribution value to a prediction score. During inference, if a new input item matches one or more stored context features or hashes, computing system 102 can retrieve and apply the corresponding contribution values to modify an initial score, probability, rank ordering, or confidence value before outputting a prediction.

In some implementations, the learned patterns can include features derived from context (e.g., surrounding data or relationships in an input), features derived from domain knowledge, learned associations, or external references, groups of features encoded into compact hash-based representations, features associated remaining contextual signals not captured by a model's primary features), or combinations thereof. The learned patterns can refer to patterns that are captured during training of the candidate function. Computing system 102 can determine, for individual features or groups of features, contributions indicating how strongly those features affect a classification decision, ranking score, predicted output, or other model-related operation.

In some implementations, computing system 102 can store the context features, hashes or other encoded representations of those features, or contributions as part of the model metadata together with the selected training parameters, performance values, and any refinement weights. During inference, computing system 102 can reload the stored features or their hashed representations and can replay or reapply their contributions to score a new input item. This can allow computing system 102 to learn information regarding contextual or knowledge-based relationships during training, which computing system 102 can inject back into inference-time scoring without requiring re-computation of the full training process. For example, for text, the learned information can include neighboring tokens, retrieved knowledge indicators, hashed co-occurrence features, and the like. For images, the learned information can include neighboring regions, contextual texture features, class-correlated region hashes, and the like. In some implementations, computing system 102 can replay the stored features during inference to modify an initial prediction score, class probability, rank ordering, or confidence value, or other predictor, or combination thereof. For example, if an input item exhibits one or more context features corresponding to stored metadata entries, computing system 102 can apply a stored contribution value, stored residual score, or stored refinement weight to the input item to produce a revised prediction output.

At step 320, a greedy algorithm may be used to determine adjustments to the parameters based on the determined accuracy. In some implementations, the greedy algorithm can operate using a successive-halving process to refine candidate parameter sets within a round or between rounds. For example, the greedy algorithm may cause certain parameters to be adjusted more than others based on the extent that the accuracy improved during a current iteration of process 300. This could include selecting a different evaluation method, box down value, RCL ticks value, and the like, to see if the accuracy score improves. Using the greedy algorithm, the adjustments to the parameters can be determined and used to execute a subsequent iteration of process 300. In some implementations, greedy adjustment can be used within a successive-halving process to refine surviving sets of candidate parameters. Alternatively, greedy search and successive halving can be executed as different optimization strategies. For example, process 300 may return to step 304 after the parameters are adjusted to select a new sample.

In some implementations, to determine whether the set of parameters is to be output, computing system 102 may be configured to analyze set of candidate parameters from least computationally expensive to most computationally expensive. For example, computing system 102 can determine whether the accuracy of the candidate function has improved since a previous iteration's candidate description. For example, given values V1 for parameters P1 (e.g., evaluation metric is Naïve Bayes, box down is set at 2×2, RCL ticks is set at 1), computing system 102 may compute an accuracy A1 for the candidate function (e.g., with parameters P1 having values V1) using the selected accuracy metric (e.g., F1). If the computed accuracy improves from a previous candidate function's corresponding accuracy score (e.g., A_prior), this can indicate that the set of parameters is expected to optimize the training of a corresponding model using the training data. Therefore, this set of parameters and values can be provided, with the training data, to the model (e.g., RCL model 110, ML model 112) for training.

In some implementations, even if the accuracy improves from a previous iteration, computing system 102 may determine that the improvement in the accuracy from the previous candidate function is less than a threshold improvement (e.g., less than a 10% improvement). In some implementations, a predefined number of iterations may be required to be performed with different configurations of parameters (or accuracy metrics) before a set of parameters is able to be identified. In some implementations, computing system 102 may determine a number of candidate functions that have been evaluated for a given dataset being analyzed for training parameters to improve the training of a model using the dataset. The number of candidate functions being less than a threshold number of candidate functions needed to be tested before the set of training parameters can be identified can indicate that this set of training parameters has not yet been identified.

In some implementations, computing system 102 can select, via a registry of pipelines, a pipeline for a data type of the training dataset including a set of pipeline components. Computing system 102 can translate one or more configuration options into a set of runtime parameters for the set of pipeline components. Computing system 102 can store the set of runtime parameters for the set of pipeline components. For example, computing system 102 can store the set of runtime parameters in memory of computing system 102. As another example, computing system 102 can store the set of runtime parameters in training data database 108. In some implementations, the set of runtime parameters can be stored so that computing system 102 can reuse the set of runtime parameters during training and inference of the candidate function. For example, if the training data includes text, computing system 102 can use a registry of pipelines to choose the text-processing pipeline. If the training dataset includes images, computing system 102 can select an image-processing pipeline. Depending on the pipeline selected, computing system 102 can convert settings, such as selected evaluation method or scaling options, into runtime settings that selected pipeline can use because that pipeline has the appropriate pipeline components.

In some implementations, the registry of pipelines can store associations between each supported data type and a corresponding pipeline definition. The pipeline definition can identify, for that data type, a set of pipeline components to be used to perform a particular task or set of tasks. For example, the set of pipeline components can identify a loader component configured to obtain and normalize source data, an encoder component configured to transform the source data into encoded feature artifacts, a builder component configured to generate or train a candidate function or model instance using the encoded feature artifacts, and an inference component configured to apply the trained candidate function or trained model instance to an input item (e.g., an input image). The registry of pipelines can allow various different data types (e.g., text datasets, image datasets, tabular datasets, large language model datasets, etc.) can each be handled through a common typed interface while still using data-type-specific implementations. In some implementations, the loader, encoder, builder, and inference components can be implemented using software modules, hardware accelerators, firmware components, or combinations thereof.

In some implementations, computing system 102 can execute the loader, encoder, builder, and inference components through a shared runner or orchestration layer. The shared runner can invoke the loader, encoder, builder, and inference components according to a calling pattern such that auto-optimization, training, and inference use a consistent execution framework across different data types. By using a consistent execution framework across different data types, duplication can be reduced, parameters can be reused, and consistency in evaluation and deployment behaviors can be improved across heterogeneous datasets.

In some implementations, computing system 102 can translate external configuration options (e.g., command-line flags, API inputs, configuration files, user selections, or combinations thereof) once into a shared runtime hyperparameter dictionary. The shared runtime hyperparameter dictionary can be stored in memory of computing system 102, training data database 108, model memory (e.g., of RCL model 110, ML model 112), or another data storage device. The shared runtime hyperparameter dictionary can be consumed by one or more of the loader, encoder, builder, and inference components. Moreover, computing system 102 can reuse the shared runtime hyperparameter dictionary for training, inference, or auto-optimization operations, or combinations thereof. In some implementations, the shared runtime hyperparameter dictionary can include an evaluation method selection, scaling settings, discretization settings, directional settings, caching controls, compression settings, refinement settings, and data-type-specific settings.

In some implementations, computing system 102 can expose common services (e.g., including caching, logging, metrics collection, artifact persistence, etc.) can be exposed through the shared runner. Computing system 102 can make each registered pipeline available irrespective of data type. As a result, encoded feature artifacts, candidate-parameter evaluations, model metadata, performance measurements, and other features, can be handled in a consistent manner across workflows (e.g., text, image, tabular, or language-model workflows).

In some implementations, computing system 102 may introduce/leverage a parameter (e.g., called “llm”). This parameter can be used by computing system 102 to instruct the algorithm to treat an input text dataset, provided it is properly formatted and structured, as a Large Language Model (LLM) dataset. When the parameter is applied, process 300, when executed by computing system 102, can train the input text dataset specifically for large language modeling. This can allow computing system 102 to leverage the vast amount of textual data to build models that can understand and generate human-like text.

In some implementations, the Naïve Bayes evaluation method may be used for training LLM datasets, based on its simplicity and effectiveness in text classification tasks. Additionally, the directional parameter mentioned above can be used when training an artificial intelligence model using the auto-optimization process for parameter determination. For example, the directional parameter can ensure that computing system 102 preserves the order of samples, such as tokens or words, which is particularly important for language modeling and understanding applications, where the sequence of words significantly impacts the model's performance.

In some implementations, computing system 102 may also include SoftMax evaluation methods when training on LLM datasets. The SoftMax evaluation method can behave like a self-attention head in a transformer network architecture, allowing the model to weigh the importance of different words in a sentence and capture complex relationships between them. This enhancement provides more advanced tools for training LLM datasets, enabling the creation of more sophisticated and accurate language models.

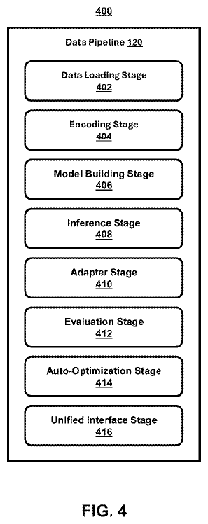

In some implementations, computing system 102 can include a data pipeline 120, which can integrate with one or more components of system 100 to transform data and build predictive models. Data pipeline 120 can process data from one form (e.g., a raw form) into another form, from which actionable insights or predictions can be derived. Deriving the data can be performed via data pipeline 120 through a series of stages. As an example, with reference to FIG. 4, a block diagram 400 of data pipeline 120 is illustrated. Data pipeline 120 may include stages such as, for example, one or more of a data loading stage 402, an encoding stage 404, a model building stage 406, an inference stage 408, an adapter stage 410, an evaluation stage 412, an auto-optimization stage 414, a unified interface stage 416, or other stages. Data can be processed by some or all of the stages in data pipeline 120. Moreover, an order of the stages can vary. In an illustrative implementation, data pipeline 120 can operate in a lifecycle including data loading, encoding, model building, evaluation and auto-optimization, artifact serialization, and inference-time replay of stored metadata.

The end-to-end flow of data pipeline 120 can include selecting, based on a data type, a pipeline from a pipeline registry. Configuration options associated with the selected pipeline can be translated into runtime parameters, and one or more sets of candidate parameters can be evaluated using respective portions of a dataset. Sets of candidate parameters that satisfy one or more performance criteria can be retained. An optimal configuration can be identified and stored. The optimal configuration can be used to perform a rollback in response to determining that subsequently evaluated sets of candidate parameters negatively impact performance. A resulting model bundle and associated metadata can be trained and stored. During inference operations, the metadata can be reloaded to replay contextual and/or refinement contributions.

Data loading stage 402 may involve data being retrieved and processed from data sources such as, for example, corpus 106 or training data database 108. Corpus 106 may store raw data or corpuses of text, while training data database 108 may store processed sequences of tokens, which can be used for training one or more models (e.g., RCL model 110, ML model 112).

Encoding stage 404 may involve encoding the retrieved data (e.g., retrieved from data loading stage 402). In some implementations, encoding stage 404 can include computing system 102 transforming input data into encoded representations. For example, computing system 102 can include a tokenizer to tokenize input data into tokens.

Model building stage 406 may involve using the encoded representations generated at the encoding stage to train a model (e.g., RCL model 110, ML model 112, etc.). In some implementations, model building stage 406 can evaluate multiple sets of candidate parameters using the encoded representations, such that previously generated encoded feature artifacts can be reused across different training configurations without repeating encoding operations. Model building stage 406 can further select, from among the sets of candidate parameters, a set of candidate parameters satisfying one or more performance criteria. Model building stage 406 can generate or refine a candidate function for the model using the selected set of candidate parameters. In some implementations, intermediate model artifacts, learned patterns, scores, or refinement, or weights, or other features, or combinations thereof, that are generated during model building, can be stored as model metadata for later reuse during inference or additional optimization.

Inference stage 408 may involve using the trained model (e.g., a trained instance of RCL model 110, a trained instance of ML model 112) to perform predictions. In some examples, inference stage 408 can include client device 104 interacting with a model, such as RCL model 110 or ML model 112, to receive predictions based on input data provided by client device 104.

Adapter stage 410 may involve a layer built on top of the initial model predictions made at inference stage 408. As used herein, an “adapter component” refers to a model component operating within data pipeline 120. Moreover, as used herein, a “refinement head” refers to an optional component configured to modify an initial score or output and can be trained and evaluated as a part of the auto-optimization process (e.g., including within an RCL workflow). A “model bundle” refers to a serialized collection of artifacts associated with the adapter component, which can include, but are not limited to, learned pattern structures, context feature definitions, residual telemetry values, scoring information, refinement-head parameters, or other metadata describing how the adapter and any refinement logic were trained and configured. For example, adapter stage 410 can include computing system 102 leveraging telemetry data and refinement heads to improve model performance. In some implementations, the candidate function and the auto-optimization process described herein can be implemented within data pipeline 120 using an adapter component or components of adapter stage 410. The adapter component can operate as part of an RCL workflow. In such implementations, the adapter component can be treated as an example model architecture or processing configuration within data pipeline 120. By treating the adapter component as an example model architecture or processing option, the adapter component can be plugged into data pipeline 120 and used as a part of normal operations of data pipeline 120. The adapter component can be loaded, encoded, built, evaluated, optimized, and used for inference through the stages of data pipeline 120 and unified interface stage 416.

In some implementations, model building stage 406 can train the adapter component using encoded representations generated by encoding stage 404 (e.g., embeddings). Model building stage 406 can generate a model bundle including, for example, learned pattern structures, context feature definitions, residual telemetry data, scoring information, a refinement component, or metadata, or other information, or combinations thereof, for describing the configuration to train the adapter. In some implementations, the refinement component can be implemented at adapter stage 410 as an optional refinement head or downstream refinement model configured to adjust an initial adapter score or classification output.

In some implementations, the model bundle generated for the adapter component can be serialized and stored as model metadata in association with the trained model (e.g., trained instances of RCL model 110, ML model 112). The stored metadata can include selected training parameters, evaluation techniques, scaling or discretization settings, directional settings, context feature identifiers or hashes, context contribution values, residual telemetry values, refinement weights associated with the refinement component, or other metadata, or combinations thereof.

During inference at inference stage 408, computing system 102 can reload the stored model metadata associated with the adapter components. Inference stage 408 can use the stored context contribution values, scoring information, residual telemetry values, or combinations thereof to refine scoring of an input item. In some implementations, adapter stage 410 can additionally reload refinement weights associated with the optional refinement head. Adapter stage 410 can apply the refinement head to an initial adapter output to produce a refined output. By applying the refinement head to the initial adapter output, adapter stage 410 can allow contextual information captured during model building stage 406 to be preserved. Moreover, by applying the refinement head to the initial adapter output, the contextual information can be more efficiently used during inference.

In some implementations, one or more hyperparameters associated with the adapter component of adapter stage 410 can be included among the runtime parameters used by auto-optimization stage 414. For example, the hyperparameters can include, but are not limited to, a learning rate, number of adapter layers, adapter size or width, an activation function, a dropout rate, a refinement threshold, or weights used to combine the adapter output with the base model output, or other hyperparameters, or combinations thereof. As another example, the runtime parameters can include, but are not limited to, a selected evaluation method, a batch size, a learning rate, a box-down setting, an RCL ticks value, an accuracy metric, a number of iterations, or hardware or pipeline settings used during training or inference, or other runtime parameters, or combinations thereof. Accordingly, auto-optimization stage 414 can tune settings specific to the adapter component together with other parameters. For example, the settings tuned specifically to the adapter component can be compared against evaluation method parameters, scaling parameters, discretization parameters, compression parameters, directional parameters, caching settings, or other settings, or combinations thereof. Evaluation stage 412 can log and cache resulting artifacts and metrics across the stages of data pipeline 120, while unified interface stage 416 can maintain consistent interaction among the stages regardless of whether the workflow processes text, image, tabular, or other data types.

Evaluation stage 412 can involve caching, logging, and evaluating data pipeline 120 and the stages of data pipeline 120 to ensure that data is being processed efficiently. Evaluation stage 412 can ensure that metrics collected are integrated across all stages of data pipeline 120, reusing data and artifacts, maintaining detailed performance logs, or computing performance metrics that are indicative of model performance. In some implementations, encoded feature artifacts, intermediate transformed data, cached pattern representations, reused training artifacts, or combinations thereof, can be stored in memory, local storage, cloud storage, and/or training data database 108 for subsequent retrieval by encoding stage 404, model building stage 406, inference stage 408, adapter stage 410, or auto-optimization stage 414. In some implementations, performance metrics, execution traces, candidate parameter scores, and data logs can be stored as metadata associated with a candidate function or trained model. The metadata can be stored, for example, within training data database 108 or other non-transitory storage accessible to or integrated within computing system 102. By storing the metadata in a centralized storage location, such as training data database 108 or memory of computing system 102, computing system 102 can reuse the metadata for subsequent operations, thereby reducing re-computations across parameter evaluations. Reducing the re-computations can improve throughput of data pipeline 120, and support more efficient model training, inference, and parameter optimization.

Auto-optimization stage 414 can involve integrating training aspects for training RCL model 110 to tune hyperparameters of RCL model 110 dynamically. By dynamically tuning its hyperparameters, auto-optimization stage 414 can ensure that RCL model 110 performs optimally over a given time period. In some implementations, auto-optimization stage 414 can evaluate multiple sets of candidate parameters across progressively larger portions of a training dataset, remove lower-performing sets of candidate hyperparameter that fail to satisfy one or more threshold criteria, and retain higher-performing set of candidate parameters for additional evaluation. For example, auto-optimization stage 414 can tune one or more runtime parameters including an evaluation method, a box-down parameter, an RCL ticks parameter, a directional parameter, a selected accuracy metric, or one or more hyperparameters specific to the adapter component of adapter stage 410. In some implementations, auto-optimization stage 414 can reuse cached encoded feature artifacts so that different sets of candidate parameters can be evaluated without recomputing the same encoded representations. Auto-optimization stage 414 can further store candidate scores, selected hyperparameter sets, or corresponding performance metrics as metadata in memory or training data database 108, enabling rollback to a previously higher-performing configuration and reuse of the selected hyperparameter set during later training and inference operations.

Unified interface stage 416 may be configured to standardize interactions among various stages of data pipeline 120. For example, unified interface stage 416 can ensure that workflows between stages, such as data loading stage 402 and encoding stage 404, remain consistent regardless of data type. In some implementations, unified interface stage 416 can provide a registry-based typed interface that forms a common seam across supported data types by mapping a given data type to a corresponding loader, encoder, model builder, inference component, or optional adapter component, such that each stage can be invoked using a common set of function calls or runtime parameters. Unified interface stage 416 can further normalize inputs, outputs, metadata, and error handling across text, image, tabular, and large language model datasets so downstream stages can operate without requiring data-type-specific control logic. In some implementations, unified interface stage 416 can coordinate the passing of cached encoded feature artifacts, performance metrics, logs, candidate parameter information, or other data, between stages of data pipeline 120 while maintaining compatibility with shared storage locations such as memory, local storage, cloud storage, and/or training data database 108. By standardizing these interactions, unified interface stage 416 can improve interoperability among stages of data pipeline 120, reduce redundant integration logic, and facilitate more efficient training, inference, and auto-optimization operations.

In some implementations, a pipeline registry can store a mapping between each supported data type and a corresponding pipeline definition. For a given data type, the pipeline definition can include or otherwise indicate a loader component, an encoder component, a builder component, and an inference component that are bound together through a single typed interface implemented by unified interface stage 416. The typed interface defines the data contracts and invocation semantics by which the loader, encoder, builder, and inference components can exchange data and are executed as a coordinated pipeline. By binding the set of pipeline components through the typed interface of unified interface stage 416, training, inference, and auto-optimization operations can be performed using a common execution framework across heterogeneous data types. Furthermore, data-type-specific implementations within the respective pipeline definitions can be permitted.

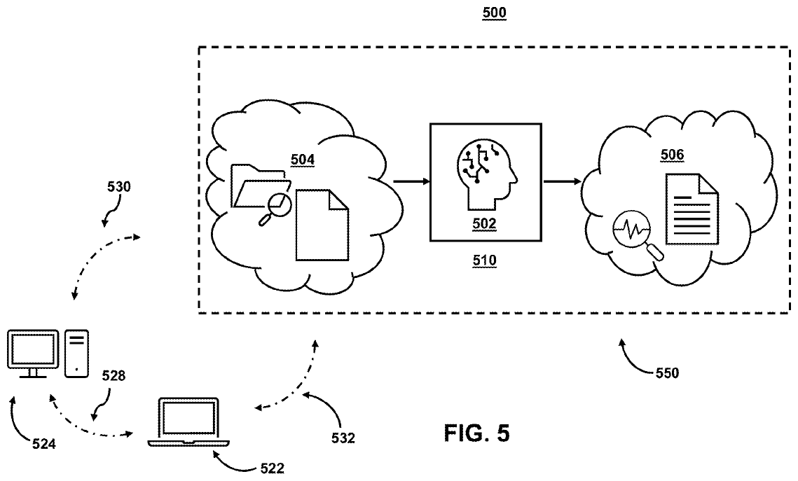

FIG. 5 is an illustrative diagram of an example system 500 used to train machine learning models, in accordance with one or more implementations. For example, FIG. 5 may show illustrative components for implementing auto-optimization processes for RCL based training (e.g., to obtain RCL-based models, such as RCL model 110) as well as non-RCL based training (e.g., to obtain ML-based models, such as ML model 112). Furthermore, system 500 can implement these techniques (e.g., RCL-training) using reduced computational resources (e.g., hardware, software), power (e.g., electricity to operate the computational resources, amount of computational resources used), and costs associated with the computational resources and power. Furthermore, the RCL framework can also be flexible enough to handle other classification tasks efficiently (e.g., small text classification tasks), even with small training data amounts.

As shown in FIG. 5, system 500 may include mobile device 522 and user terminal 524. Computing system 102 or client device 104 of FIG. 1 may be implemented using one or more of mobile device 522 or user terminal 524, as well as other devices, systems, services, etc. While shown as a smartphone and personal computer, respectively, in FIG. 5, it should be noted that mobile device 522 and user terminal 524 may be any computing device, including, but not limited to, a laptop computer, a tablet computer, a hand-held computer, and other computer equipment (e.g., a server), including “smart,” wireless, wearable, or mobile devices.

FIG. 5 also includes cloud-based components 510. cloud-based components 510 may alternatively be any computing device as described above, and may include any type of mobile terminal, fixed terminal, or other device. For example, computing system 102 can be implemented using cloud-based components 510. In some implementations, cloud-based components 510 may be implemented as a cloud computing system and may feature one or more component devices. It should also be noted that system 500 is not limited to three devices. Users may, for instance, utilize one or more devices to interact with one another, one or more servers, or other components of system 500. It should be noted that, while one or more operations are described herein as being performed by particular components of system 500, these operations may, in some implementations, be performed by other components of system 500. As an example, while one or more operations are described herein as being performed by components of mobile device 522, these operations may, in some implementations, be performed by components of cloud-based components 510. In some implementations, the various computers and systems described herein may include one or more computing devices that are programmed to perform the described functions. Additionally, or alternatively, multiple users may interact with system 500 or one or more components of system 500. For example, in one implementation, a first user and a second user may interact with system 500 using two different components.

With respect to the components of mobile device 522, user terminal 524, and cloud-based components 510, each of these devices may receive content and data via input/output (hereinafter “I/O”) paths. Each of these devices may also include processors or control circuitry to send and receive commands, requests, and other suitable data using the I/O paths. The control circuitry may comprise any suitable processing, storage, or input/output circuitry. Each of these devices may also include a user input interface or user output interface (e.g., a display) for use in receiving and displaying data. For example, as shown in FIG. 5, both mobile device 522 and user terminal 524 include a display upon which to display data.

Additionally, as mobile device 522 and user terminal 524 are shown as touchscreen smartphones, these displays also act as user input interfaces. It should be noted that in some implementations, the devices may have neither user input interfaces nor displays and may instead receive and display content using another device (e.g., a dedicated display device such as a computer screen, or a dedicated input device such as a remote control, mouse, voice input, etc.). Additionally, the devices in system 500 may run an application (or another suitable program). The application may cause the processors or control circuitry to perform operations related to a desired task or set of tasks.

Each of these devices may also include electronic storage. The electronic storage may include non-transitory computer-readable storage media that electronically stores information, such as, but not limited to, computer program instructions. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically readable storage media. The electronic storage may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 5 also includes communication paths 528, 530, and 532. Communication paths 528, 530, and 532 may include the Internet, a mobile phone network, a mobile voice or data network (e.g., a 5G or LTE network), a cable network, a public switched telephone network, or other types of communications networks or combinations of communications networks. Communication paths 528, 530, and 532 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, or firmware components operating together. For example, the computing devices may be implemented by a cloud of computing platforms operating together as the computing devices.

cloud-based components 510 may include one or more components of system 100 of FIG. 1. cloud-based components 510 may access one or more databases (e.g., corpus 106, training data database 108). In some examples, cloud-based components 510 may access a cloud-based memory. The cloud-based memory may store a model, such as RCL model 110, ML model 112, or other models. In some examples, cloud-based components 510 may leverage cloud-based memory to access and execute the auto-optimization process (e.g., instructions).

cloud-based components 510 may include model 502, which may be a machine learning model, artificial intelligence model, etc. (which may be referred collectively as “models” herein). In some examples, model 502 may represent an instance of RCL model 110. In some examples, model 502 may represent an instance of ML model 112. To train model 502 as an RCL model (e.g., RCL model 110), the previously described RCL training process may be performed. To train model 502 as an ML model (e.g., ML model 112), a different process may be performed.

In some implementations, if model 502 refers to ML model 112, model 502 may take inputs 504 (e.g., multidimensional joined matrices, images) and provide outputs 506 (e.g., predicted next token/word, classifications). The inputs may include multiple datasets, such as a training dataset, a test dataset, and a validation set. In some implementations, outputs 506 may be fed back to model 502 as input to train model 502 (e.g., alone or in conjunction with user indications of the accuracy of outputs 506, labels associated with the inputs (e.g., an indication of the actual next token or the candidate next tokens along with their probabilities, or with other reference feedback information). In a variety of implementations, model 502 may update its configurations (e.g., weights, biases, or other parameters) based on the assessment of its prediction (e.g., outputs 506). For example, the updates may be based on RCL optimization performed by determining similarities between randomly selected similar and different sample sequences.

In some implementations, where model 502 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the 502 may be trained to generate better predictions.

In some implementations, model 502 may include an artificial neural network (i.e., ML model 112). In such implementations, model 502 may include an input layer and one or more hidden layers. Each neural unit of model 502 may be connected with many other neural units of model 502. Such connections can be enforcing or inhibitory in their effect on the activation state of connected neural units. In some implementations, each individual neural unit may have a summation function that combines the values of all of its inputs. In some implementations, each connection (or the neural unit itself) may have a threshold function such that the signal must surpass it before it propagates to other neural units. Model 502 may be self-learning and trained, rather than explicitly programmed, and can perform significantly better in certain areas of problem solving, as compared to traditional computer programs. During training, an output layer of model 502 may correspond to a classification of model 502, and an input known to correspond to that classification may be input into an input layer of model 502 during training. During testing, an input without a known classification may be input into the input layer, and a determined classification may be output.

In some implementations, where model 502 refers to ML model 112, model 502 may include multiple layers (e.g., where a signal path traverses from front layers to back layers). In some implementations, back propagation techniques may be utilized by model 502 where forward stimulation is used to reset weights on the “front” neural units. In some implementations, stimulation and inhibition for model 502 may be more free-flowing, with connections interacting in a more chaotic and complex fashion. During testing, an output layer of model 502 may indicate whether or not a given input corresponds to a classification of model 502 (e.g., evaluation metric scores or model performance scores). However, RCL-based models, such as RCL model 110, may not necessitate multi-layer model architectures, and can instead operate on a single node, or single-parent node-like design.

System 500 also includes API layer 550. API layer 550 may allow the system to generate summaries across different devices. In some implementations, API layer 550 may be implemented on mobile device 522 or user terminal 524. Alternatively, or additionally, API layer 550 may reside on one or more of cloud-based components 510. API layer 550 (which may be A REST or Web services API layer) may provide a decoupled interface to data or functionality of one or more applications. API layer 550 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 550 may use various architectural arrangements. For example, system 500 may be partially based on API layer 550, such that there is strong adoption of SOAP and RESTful Web-services, using resources like Service Repository and Developer Portal, but with low governance, standardization, and separation of concerns. Alternatively, system 500 may be fully based on API layer 550, such that separation of concerns between layers like API layer 550, services, and applications are in place.

In some implementations, the system architecture may use a microservice approach. Such systems may use two types of layers: Front-End Layer and Back-End Layer where microservices reside. In this kind of architecture, the role of the API layer 550 may provide integration between Front-End and Back-End. In such cases, API layer 550 may use RESTful APIs (exposition to front-end or even communication between microservices). API layer 550 may use AMQP (e.g., Kafka, RabbitMQ, etc.). API layer 550 may use incipient usage of new communications protocols such as gRPC, Thrift, etc.

In some implementations, the system architecture may use an open API approach. In such cases, API layer 550 may use commercial or open source API Platforms and their modules. API layer 550 may use a developer portal. API layer 550 may use strong security constraints applying WAF and DDoS protection, and API layer 550 may use RESTful APIs as standard for external integration.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein can be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining can be stationary (e.g., permanent or fixed) or moveable (e.g., removable or releasable). Such joining can be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements can differ according to other exemplary implementations, and such variations are intended to be encompassed by the present disclosure.

What is claimed is:

1. A method, implemented using one or more processors, comprising:
selecting a set of parameters for a candidate function describing a relationship between a first class of images and a second class of images from a training dataset, wherein the training dataset comprises a plurality of images comprising a first label or a second label to indicate that a given image was classified into the first class of images or the second class of images, respectively;
for each of a set of sample images:
determining, using the candidate function having the set of parameters, a predicted label for a sample image randomly selected from the training dataset; and
extracting values associated with the set of parameters for the candidate function based on the predicted label for the sample image;
computing an accuracy of the candidate function using an accuracy metric; and
outputting, based on the accuracy satisfying a performance criterion, one or more training parameters.

2. The method of claim 1, wherein the set of parameters comprises a first set of parameters, the values comprise first values, and the accuracy comprises a first accuracy, computing the accuracy comprises:
determining, using a greedy algorithm, one or more adjustments to the first set of parameters to obtain a second set of parameters for the candidate function;
extracting, using the second set of parameters for the candidate function, second values for the second set of parameters;
computing a second accuracy for the candidate function based on the second set of parameters, wherein outputting the one or more training parameters comprises outputting the second set of parameters with the second values for training a model using the training dataset and the one or more training parameters.

3. The method of claim 1, further comprising:
splitting the training dataset into (a) a learning set comprising a first subset of training images having the first label and a second subset of training images having the second label and (b) a testing set comprising a first subset of testing images having the first label and a second subset of testing images having the second label, the accuracy metric indicating the accuracy of the candidate function being computed based on the testing set.

4. The method of claim 1, wherein selecting the set of parameters comprises:
applying a flag to the candidate function to trigger a collapse of one or more patterns having a pattern frequency less than a threshold pattern frequency into one pattern that is incorporated into the candidate function.

5. The method of claim 1, wherein the set of parameters comprises a downscaling parameter, selecting the set of parameters comprises:
selecting one or more dimensions for a box-shaped region within the sample image that the downscaling parameter is applied to reduce an image resolution of the sample image based on averaging pixel values within the box-shaped region.

6. The method of claim 1, wherein the set of parameters comprise a discretization parameter, selecting the set of parameters comprises:
mapping byte values into a predefined range of symbols to compress the sample image.

7. The method of claim 1, wherein the set of parameters comprises a directional parameter that preserves an order that features are extracted from each sample image.

8. The method of claim 1, wherein computing the accuracy of the candidate function comprises:
calculating a balance score representing how balanced the training dataset is with respect to the first label and the second label; and
selecting, from a plurality of accuracy metrics, the accuracy metric to compute the accuracy of the candidate function based on the balance score.

9. The method of claim 1, wherein the set of parameters comprises a first set of parameters and the accuracy comprises a first accuracy, the accuracy satisfying the performance criterion comprises:
modifying one or more parameters of the first set of parameters to generate a second set of parameters;
computing a second accuracy of the candidate function using the accuracy metric based on the second set of parameters; and
determining that the second accuracy of the candidate function for the second set of parameters is less than the first accuracy of the candidate function indicating that the second set of parameters fail to improve the accuracy.

10. The method of claim 1, wherein satisfying the performance criterion comprises:
calculating an accuracy change from a previous iteration; and
determining that the accuracy change is less than a threshold accuracy change indicating that the accuracy is a maximum accuracy.

11. The method of claim 1, further comprising:
adjusting one or more values of the set of parameters based on a loss computed using the predicted label for the sample image and a ground truth label for the sample image, the ground truth label comprising the first label or the second label.

12. The method of claim 1, further comprising:
evaluating a first plurality of sets of candidate parameters for the candidate function using a first portion of the training dataset;
identifying one or more sets of candidate parameters of the first plurality of sets of candidate parameters having a performance score less than a lower bound threshold;
removing the one or more sets of candidate parameters from the first plurality of sets of candidate parameters to obtain a second plurality of sets of candidate parameters having fewer sets of candidate parameters than the first plurality of sets of candidate parameters; and
evaluating the second plurality of sets of candidate parameters using a second portion of the training dataset different from the first portion and including a greater quantity of samples than the first plurality of sets of candidate parameters, the set of parameters comprising at least one of the second plurality of sets of candidate parameters.

13. The method of claim 12, wherein selecting the set of parameters comprises:
identifying less than a threshold quantity of sets of candidate parameters within the second plurality of sets of candidate parameters having the performance score less than a first threshold; and
selecting a set of candidate parameters from the second plurality of sets of candidate parameters having the performance score greater than or equal to a second threshold, the set of parameters comprising the set of candidate parameters.

14. The method of claim 12, wherein identifying the one or more sets of candidate parameters comprises:
calculating a quantity of sets of candidate parameters included by the first plurality of sets of candidate parameters; and
tuning, based on the quantity of sets of candidate parameters, the lower bound threshold such that the one or more sets of candidate parameters comprises at least half of the first plurality of sets of candidate parameters.

15. The method of claim 12, further comprising:
selecting a set of candidate parameters from the second plurality of sets of candidate parameters having the performance score greater than or equal to a first threshold; and
storing, in memory, the set of candidate parameters, wherein the one or more training parameters comprise the set of candidate parameters.

16. The method of claim 1, further comprising:
selecting, via a registry of pipelines, a pipeline for a data type of the training dataset comprising a set of pipeline components;
translating one or more configuration options into a set of runtime parameters for the set of pipeline components; and
storing, in memory, the set of runtime parameters for the set of pipeline components to be reused during training and inference of the candidate function.

17. The method of claim 1, wherein the set of parameters comprise a first set of candidate parameters, the method further comprises:
caching one or more encoded feature artifacts of the training dataset for the first set of candidate parameters; and
evaluating a second set of candidate parameters using at least one of the one or more encoded feature artifacts.

18. The method of claim 1, further comprising:
training, using the one or more training parameters, the candidate function to learn one or more patterns for generation of predictions;
storing the one or more patterns and the accuracy of the candidate function as model metadata with the one or more training parameters; and
training a refinement model using outputs of the one or more patterns to obtain a set of weights added to the model metadata, the set of weights being used to refine a classification output based on the one or more patterns.

19. A system, comprising:
one or more non-transitory computer-readable media storing computer program instructions; and
one or more processors that execute the computer program instructions to cause the one or more processors to:
select a set of parameters for a candidate function describing a relationship between a first class of data and a second class of data from a training dataset, wherein the training dataset comprises a plurality of data items that are assigned a first label or a second label to indicate that a given data item was classified into the first class of data or the second class of data, respectively;
for each of a set of data items:
determine, using the candidate function having the set of parameters, a predicted label for a data item randomly selected from the training dataset; and
extract values associated with the set of parameters for the candidate function based on the predicted label for the data item;
compute an accuracy of the candidate function using an accuracy metric; and
output, based on the accuracy satisfying a performance criterion, one or more training parameters.

20. One or more non-transitory computer-readable media storing computer program instructions that, when executed by one or more processors, effectuate operations comprising:
selecting a set of parameters for a candidate function describing a relationship between a first class of data and a second class of data from a training dataset, wherein the training dataset comprises a plurality of data items that are assigned a first label or a second label to indicate that a given data item was classified into the first class of data or the second class of data, respectively;
for each of a set of data items:
determining, using the candidate function having the set of parameters, a predicted label for a data item randomly selected from the training dataset; and
extracting values associated with the set of parameters for the candidate function based on the predicted label for the data item;
computing an accuracy of the candidate function using an accuracy metric; and
outputting, based on the accuracy satisfying a performance criterion, one or more training parameters.
